(19) United States
(12) Patent Application Publication
(10) Pub. No.: US 2009/0061207 A1
(43) Pub. Date: Mar. 5, 2009

(54) Impregnation apparatus and method

(75) Inventors: Colin W. Spencer, Bilgola (AU); Michael Kennedy, Indooroopilly (AU); Jeremy Christmas, Auckland (NZ)

Correspondence Address: EDWARDS ANGELL PALMER & DODGE LLP, P.O. BOX 55874, BOSTON, MA, 02205, US

(73) Assignees: The State of Queensland acting through The Dept. of Primary Industries and Fisheries, Queensland (AU); Carter Holt Harvey Wood Products Australia Pty Ltd, Victoria (AU); Colin William Spencer, Bilgola, New South Wales (AU)

(21) Appl. No.: 11/664,303

(22) PCT Filed: Sep. 30, 2005
(86) PCT No.: PCT/IB05/53222

§ 371 Date: Aug. 21, 2008

(30) Foreign Application Priority Data
Sep. 30, 2004 (AU) 2004905664

(51) Int. Cl. B32B 3/26; B05C 5/00; B05D 3/00

(52) U.S. Cl. 428/320.2; 118/300; 118/696; 427/345; 427/384

(57) ABSTRACT

Apparel us for impregnating a porous substrate (e.g., wood) with an active agent, including a reservoir for containing a low boiling fluid, a controllable first fluid pathway to permit fluid to flow from the reservoir to a treatment vessel, a fluid junction for introducing the active agent into the first fluid pathway to permit mixing of the active agent with the low boiling fluid to produce an impregnation fluid containing an initial level of active agent and a controllable second fluid pathway to allow fluid to flow from the treatment vessel to the reservoir. The treatment vessel contains the porous substrate while it contacts the impregnation fluid in a liquid state to produce a treated substrate impregnated with the active agent. Also, a method for impregnating a substrate with an active agent, including preparing an impregnation fluid including a low boiling solvent and an active agent, and optionally a co-solvent, contacting the porous substrate with the impregnation fluid in a liquid substrate in an impregnation chamber and removing the impregnation fluid.

### TECHNICAL FIELD

The invention relates to an apparatus and method for impregnating porous substrates with active agents. In particular, the invention relates to an apparatus and method for the impregnation of wood with agents which counter degradation of the wood.

### BACKGROUND ART

The simplest procedure for incorporating an active agent into a porous material, such as wood, is to soak the porous material in a bath containing a solution in which is dissolved or suspended an active agent, allowing the solution to penetrate into the pores of the porous material, removing the soaked material from the solution and allowing it to dry. The solvent is usually selected so as to preferentially evaporate, leaving the active agent behind in the pores of the porous material.

One embodiment of this fairly simple process is the process used to incorporate boron compounds (for example, boric acid) into wood for protection against borers. The wood to be treated is placed in an aqueous solution of the boron compounds until the solution has adequately soaked into the pores of the material. The process is fairly slow and depends on the nature of the wood and the cross-sectional area of the material which is to be impregnated. When the wood is believed to be sufficiently soaked through with the treating solution, it is removed from the bath and the solvent is allowed to drain off. The wood is then left to dry naturally before being used. The water content of such treated woods is usually very high when freshly treated.

In some cases alternate applications of vacuum and pressure are used to force the preservative solution into the wood. A vacuum may sometimes be used to remove excess fluid. However, the final drying step, in which the preservative binds to the wood, is invariably completed by natural drying because accelerated drying interferes with the binding process, degrades the product, or the capital equipment is too expensive for the time gained. This drying step is the rate determining step for the whole process.

One alternative impregnation process involves active ingredients dissolved in light organic solvents, usually referred to as LOSP (Light Organic Solvent Preservation) process. The LOSP process is widely used for the impregnation of wood with water-insoluble, organic active agents such as fungicides (for example copper naphthenate) and insecticides (such as synthetic pyrethroids).

The LOSP process is herein described with reference to a specific example, namely the incorporation of copper naphthenate into radiata pine.

Copper naphthenate is a fungicide and is available commercially as a solution in liquid hydrocarbons containing 5% or 8%. The copper naphthenate is diluted to a desired working strength by the addition of further quantities of hydrocarbon or white spirit, which act as a carrier.

The radiata pine is then placed in an autoclave which is then flooded with the copper naphthenate solution. The timber is then subjected to various cycles that may involve vacuum or pressure, then the solvent is drained away and excess working solution is removed from the timber by vacuum. The treated timber is then removed from the autoclave, still wet with solvent. The residual solvent in the wood is typically left to evaporate naturally. Solvent remaining in the wood migrates to the wood surface by capillary action and eventually evaporates.

The LOSP process has a number of drawbacks. In particular, much of the solvent used is not recovered. In particular the solvent remaining in the wood after removal from the autoclave is lost to the atmosphere. The wood can also become difficult to handle and use if it is stacked in a manner which prevents complete solvent evaporation.

This loss of solvent has a significant disadvantage from the points of view of cost and environmental impact. The solvents may also be hazardous, for example, be toxic, or flammable.

Further, the reliance on an evaporation to remove excess solvent also means that the final drying step is slow. The result is a long entry-to-exit time of radiata pine at the treatment plant, or the release into use of incompletely dry product, leading to odour, painting and gluing problems. The delay in turnaround time to ensure adequate post-treatment drying has implications in terms of cost.

Further, the LOSP process is also not amenable to the impregnation of wood with substances which have inherent low solubility in the solvent of choice. In order for wood to be retreated with an additional active agent, if this is necessary, the drying step needs to be wholly or substantially completed before the process can be repeated.

Another alternative process uses aliphatic hydrocarbons such as propane, butane, pentane or mixtures thereof under pressure so that the aliphatic hydrocarbon is in the liquid phase as the carrier solvent. A major disadvantage of this process is the flammable and explosive properties of the solvent.

Other alternative processes are available which use supercritical CO₂. However, these are very expensive and the substantial costs associated with such technology are unlikely to replace methods and apparatus which rely on more traditional solvents in the near future.

Still other alternative processes exist that involve contacting the wood with solvent vapours at elevated temperatures. Processes involving contacting hot solvent vapours with wood can result in the leaching of compounds, particularly fatty compounds, from the wood. This can be undesirable as the mechanical properties of the wood can be altered as a result of the leaching of compounds from the wood matrix by the hot solvent vapours.

It is an object of the present invention to overcome or ameliorate at least one of the disadvantages of the prior art, or to provide a useful alternative.

### DESCRIPTION OF THE INVENTION

According to a first aspect the invention provides an apparatus for impregnating a porous substrate with an active agent, said apparatus including:

(a) a reservoir for containing a low boiling fluid,
(b) a controllable first fluid pathway to permit fluid to flow from said reservoir to a treatment vessel
(c) a fluid junction for introducing an active agent into said first fluid pathway to permit mixing of said active agent with said low boiling fluid to produce an impregnation fluid containing an initial level of active agent;
(d) a controllable second fluid pathway to allow fluid to flow from said treatment vessel to said reservoir; and wherein
said treatment vessel is adapted to contain a porous substrate and permit said porous substrate to contact said impregnation fluid in a liquid state, thereby producing a treated substrate with an increased amount of said active agent relative to the porous substrate and a depleted impregnation fluid with a reduced amount of active agent relative to the impregnation fluid.

The apparatus preferably includes a means for introducing a co solvent which acts to assist in solubilising the active agent in the low boiling fluid. Preferably, the apparatus includes a co solvent fluid junction for combining a co solvent with the active and/or combining the co solvent with the low boiling fluid.

Preferably the apparatus includes a pump for introducing said impregnation fluid via said first fluid pathway into said treatment vessel at a controlled rate, and temperature control means for introducing said active mixture at a predetermined temperature. Suitable temperatures and pressures are selected depending on the nature of the solvent used and the soluble substances desired to be impregnated as well as the size and porosity of the porous substrate.

Preferably the apparatus further includes a pump for removing said depleted impregnation fluid via said second fluid pathway. More preferably the apparatus further includes a pump for removing at least a portion of said depleted impregnation fluid in a liquid state via said second fluid pathway to a said reservoir and an entrainer for removing at least a portion of said depleted impregnation fluid in a gaseous state via said second fluid pathway to said reservoir.

In one preferred embodiment, the treatment vessel is configured such that the porous substrate for treatment therein is contacted by a liquid mixture of low boiling fluid containing active agent dissolved therein, with minimal or no contact of the material for treatment being contacted by low boiling solvent vapours. This may involve, for instance, flooding the treatment chamber from a lower portion of the treatment vessel, i.e. the treatment chamber is preferably flooded from an inlet at, near, or on the bottom, rather than the top. By keeping the material to be treated immersed in a liquid low boiling solvent/active, extensive ongoing leaching of substances from the material to be treated is controlled.

It is also preferred if the treatment vessel is sized and/or filled with porous material so as to be substantially full, i.e. with minimal volume occupied only by the liquid low boiling solvent/active mixture. The treatment vessel is therefore preferably sized with respect to the porous material intended to be treated, so the vessel is substantially filled with the porous material. Alternatively, the porous material is chosen in an amount and placed in the vessel such that the vessel is substantially full. In order to avoid large “dead volumes” of impregnation fluid, inert non-porous bodies can be placed in the chamber to fill voids.

The temperature and pressure are maintained in the treatment vessel such that the low boiling solvent/active are kept liquid at all times. If the mixture is allowed to become a vapour, either by reduction of amount of low boiling solvent/active or increase in temperature, the low boiling solvent will be vapourised but the less volatile active may not. In effect, a vapour phase depleted in terms of the amount of active will be generated which will become an extractive fluid, with the potential to remove any active already impregnated along with any other extractable components from the wood.

In a liquid low boiling solvent/active mixture, with a low dead volume, any native substances leached from the wood will soon equilibrate, and will not be extensively leached from the wood as may happen if contact was with the vapour phase.

Temperature can be controlled by heating or cooling, and pressure can be controlled by adding/removing an amount of the liquid low boiling solvent/active mixture from the treatment vessel.

Preferred temperatures of operation are in the range 40 to 60° C. Preferred pressures are in the range up to 2000 KPa.

Preferably the entrainer is maintained at a temperature similar to, or lower than that of the treatment vessel, with any liquid or vapour being drawn from the treatment vessel under low pressure. Desirably residual heat contained in the timber provides a heat source for the evaporation of the liquid contained in the timber whilst the entrainer maintains a controlled temperature and pressure to extract the vapours.

Desirably, heat exchangers operate with the entrainer to provide a heat balance and to control pressure differentials throughout the system. One heat exchanger operates to warm the impregnation fluid in the first fluid pathway and increase the pressure thereof prior to entering the treatment vessel. Another heat exchanger may operate to cool the residual impregnation fluid and provide a low pressure at the entrainer to further cool and condense the mixture. The pressures and temperatures are related by the vapour pressure/temperature properties of the selected solvent but may be modified with respect to the pressure/temperature characteristics of the pure substance by the presence of the active agent or agents. The use of the entrainer minimises solvent losses and aids in solvent recycling.

A refrigeration circuit, is used to control the temperature and pressure differentials at relevant points in the apparatus i.e. for heating and pressurising the solvent and for cooling and reducing the pressure at the entrainer for solvent recovery. The refrigeration circuit typically contains components such as a compressor, heat exchangers, and pumps.

The system is configured such that energy efficiency is maximised by maintaining heat balance in the system by way of a condensor/de-superheater.

Most preferably, the apparatus is a closed system which allows for recovery and recycling of the solvent, and where the system is adapted to be fluid tight at elevated pressures.

It is preferred if the system can be evacuated to remove air prior to commencement of the process, and can allow reintroduction of air to atmospheric pressure in a controlled manner when the process is completed.

In one preferred embodiment, the fluid junction is an injector port for the introduction of a predetermined amount of said active agent, either alone or in combination with a low boiling solvent or another active or inert carrier.

Preferably, the treatment vessel includes a vacuum pump to remove any further remaining low boiling solvent from the treatment vessel and/or from the porous substrate.

Preferably, if the low boiling solvent is microwave volatile (for instance, a polar low boiling solvent) the treatment vessel further includes a microwave source to apply microwave energy to said porous material to assist in removal of the low boiling solvent and/or impregnation fluid and/or depleted impregnation fluid after the impregnation of said porous material. Those skilled in the art will of course appreciate that the use of microwaves on wood needs to have regard to retaining sufficient moisture content in the wood (usually of the order of 10-15%) to retain suitable dimensional stability.

Without wishing to be bound by theory, it is believed that the combination of elevated temperature and pressure enhances the impregnation efficiency by improving the penetrating activity of the soluble substances in the solvent, and allowing equilibrium to be reached more quickly. Further, it is believed that the process is accelerated by the inherent low surface tension of the preferred low boiling solvents.

According to a second aspect the invention provides a method for impregnating a substrate with an active agent, said method including:

a) preparing an impregnation fluid including a low boiling solvent and an active agent,
b) contacting a porous substrate with said impregnation fluid in a liquid state in a sealed impregnation chamber for a time sufficient to allow said fluid to penetrate the pores of said porous substrate, and
c) removing said impregnation fluid in a liquid state from said impregnation chamber and returning to a reservoir.

The method may also involve an optional step of entraining fluids in a gaseous state from said impregnation chamber, condensing said fluids to a liquid state and returning to said reservoir.

Preferably, the porous substrate has no, or minimal, contact with solvent in the vapour phase.

Once the impregnation fluid has been removed from the treatment chamber, the treatment chamber may be subject to vacuum to remove any residual low boiling fluid in the chamber and/or in the porous substrate.

The method may further include the application of microwave energy for the removal of solvents from said porous substrate.

Preferably, the impregnation fluid is prepared by direct introduction of said active agent into said solvent.

Preferably, the active mixture is introduced into the treatment vessel at a controlled rate and at a predetermined temperature. Suitable temperatures and pressures are selected depending on the nature of the solvent used and the soluble substances desired to be impregnated as well as the size and porosity of the substrate.

Preferably, the method of the present invention is operated in conjunction with a heat exchange system to provide a heat balance and to control pressure differentials throughout the system. One heat exchanger operates to warm the liquid solvent and increase the pressure thereof prior to entering the treatment vessel. Another heat exchanger may operate to cool the recycled solvent and provide a low pressure at the entrainer to further cool and condense the mixture. The pressures and temperatures are related by the vapour pressure/temperature properties of the selected solvent but may be modified with respect to the pressure/temperature characteristics of the pure substance by the presence of the active agent or agents.

Preferably, the method of the present invention is operated in a continuous fashion. In one highly preferred method of operation, the steps may be repeated continuously until the desired levels of impregnation of the substrate have been reached.

Any suitable low boiling solvent such as low boiling hydrocarbons, low boiling hydrochlorofluorocarbons and hydrofluorocarbons may be used in the apparatus and process of the present invention. Suitable solvents include, but are not limited to, methane, ethane, propane, butane, isobutane, fluorinated hydrocarbons such as chlorodifluoromethane (R22), 1,1,1,2-tetrafluoroethane (R134a), 1,1,1-trifluoroethane (R143a), pentafluoroethane (R125), 1,1-difluoroethane (R152a) and difluoromethane (R32). The solvent may be a mixture of solvents and the apparatus and method of the invention may also utilise a number of solvents applied to the substrate in a series of successive impregnations.

A highly preferred solvent is pentafluoroethane (R125).

Preferably, a co-solvent is used to assist in solubilising the active in the low boiling solvent. The co solvent is preferably present in an amount (by wt %) of less than 5% of the total impregnating fluid. More preferably, it is present in an amount of less than 3%, even more preferably less than 2% and most preferably, present in an amount of less than 1%. As little as 1 ppb co-solvent may be used.

The co-solvent preferably does not remain behind when the impregnating fluid is evaporated. A suitable co solvent may therefore be one with a boiling point lower than the boiling point of the low boiling solvent. More preferably, the co-solvent forms an azeotrope or zeotrope with the low boiling solvent. If azeotropic mixtures are found, this allows the use of co-solvents which have a boiling point higher than that of the low boiling solvent. Preferably, the azeotropic mixture exists at the range of temperatures and pressures at which the low boiling solvent is volatilised. Most preferably, the co-solvent is 1,2-dichloroethylene, and more preferably trans-1,2-dichloroethylene.

In one preferred embodiment, the low boiling solvent is a HFC and the co-solvent is 1,2-dichloroethylene. A particularly highly preferred embodiment involves the use of pentafluoroethane with trans-1,2-dichloroethylene. For example pentafluoroethane with 1-3% trans-1,2-dichloroethylene.

The invention is not restricted to any particular active. Any active soluble in the low boiling solvent, or soluble in the low boiling solvent/co-solvent mixture may be used.

It is preferred if the active is biocidal.

Any suitable metallic biocides such as copper or tin naphthenates, or non-metallic biocides such as azoles or pyrethroids, may be used in the apparatus and process of the present invention. Other suitable actives include creosote (including coal tars) CRT, pentachlorophenol and related chlorophenols PCP, disodium octaborate tetrahydrate BOC, copper-8-quinolinolate CUQ and zinc naphthenate.

However, non biocidal actives, such as pigments, dyes, perfumes, sealants etc are all contemplated as being impregnated into porous materials. While this invention is described with reference to wood as the porous material, it will be understood that any porous material, natural or man made, organic or inorganic, may be impregnated by the apparatus and method disclosed herein.

According to a third aspect, the invention provides a method for impregnating a porous substrate with an active agent, said method including subjecting the substrate to an impregnating exposure of a liquid impregnation fluid comprising an active agent and a low boiling solvent; and volatilising at least a portion of said low boiling solvent to leave a portion of said active in said substrate.

Preferably, the method of the third aspect involves impregnating a porous substrate with an active agent, said method including subjecting the substrate to an impregnating exposure of a liquid impregnation fluid comprising an active agent; a low boiling solvent and a co solvent; and volatilising at least a portion of said low boiling solvent and said cosolvent to leave a portion of said active in said substrate.

More preferably, the invention provides a method for impregnating a porous substrate with an active agent, said method including subjecting the substrate to an impregnating exposure of a liquid impregnation fluid comprising an active agent and a low boiling solvent; removing in liquid form at least some of said liquid impregnation fluid; and subjecting said substrate to volatilisation to volatilise at least a portion of said low boiling solvent to leave a portion of said active in said substrate.

More preferably, the invention provides a method for impregnating a porous substrate with an active agent, said method including subjecting the substrate to an impregnating exposure of a liquid impregnation fluid comprising an active agent; a low boiling solvent and a co-solvent; removing in liquid form at least some of said liquid impregnation fluid; and subjecting said substrate to volatilisation to volatilise at least a portion of said low boiling solvent and said co-solvent to leave a portion of said active in said substrate.

The method of the present invention allows for variable depths of penetration to be achieved. This can be advantageous, as for example some substances, such as biocides, would normally require full penetration. Others, such as colourants, would require only a surface or envelope treatment. Other agents, such as water repellents, may require different levels of penetration, depending upon the intended application.

In other embodiments of the invention, it is possible to carry out multiple impregnation steps—for example, with multiple biocides. It is also possible to carry out multiple sequential impregnation steps, where different penetration levels of different agents are desired. For example, in one preferred embodiment, wood could be treated with a biocidal agent in a manner to achieve full penetration. Subsequent to this, a partial or envelope penetration with a water repellent treatment and/or a colouring agent could be used.

The apparatus of the present invention can employ single or multiple reservoirs or inlet ports to facilitate multiple impregnation steps.

According to a fourth aspect, the invention provides a porous substrate impregnated by the apparatus of the first aspect.

According to a fifth aspect, the invention provides a porous substrate impregnated according to the method of the second or third aspects.

### DESCRIPTION OF THE DRAWINGS

FIG. 1 shows a schematic drawing of a solvent impregnation apparatus of the present invention.

FIG. 2 shows a further alternative embodiment of a solvent impregnation apparatus of the present invention.

FIG. 3 shows the general scheme of the method and apparatus of the present invention.

### DESCRIPTION OF THE INVENTION

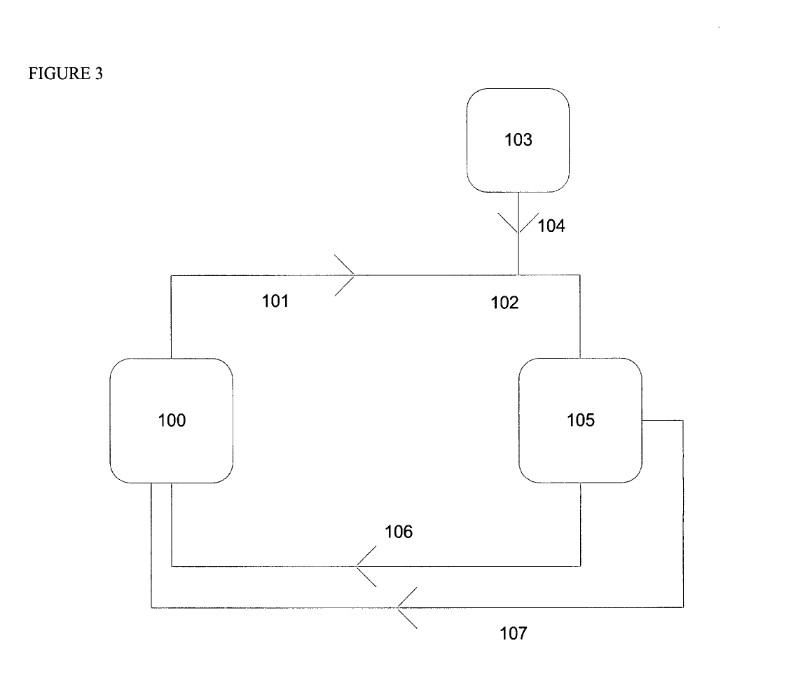

The general scheme of the apparatus and method of the present invention are shown in FIG. 3. Reservoir 100 contains a low boiling solvent. This passes via fluid pathway 101 to mixing junction 102. Treatment agent, is added via fluid pathway 104, and may be contained prior to addition in reservoir 103.

A co solvent, if used, can be added either to the treatment agent prior to entering via fluid pathway 104, or can be added into reservoir 100. Alternatively, co-solvent may be dosed in at or after mixing junction 102 if desired. Preferably, co-solvent and treating agent are combined in reservoir 103 prior to use.

Discussion with reference to a low boiling solvent herein is taken to include reference to a single low boiling solvent, a mixture of low boiling solvents and or any co-solvents as required.

The impregnation fluid, comprising low boiling solvent and active is brought into contact, in a liquid state, with the porous substrate in treatment vessel 105. Following treatment with the liquid impregnation fluid, the liquid impregnation fluid is removed by fluid pathway 106. It may be treated further, for example allowed to expand, causing the active agent to drop out of solution, and then returned to reservoir 100, or the whole impregnation fluid may be returned to reservoir 100 for re use.

The porous substrate, impregnated with impregnation fluid, may then be subjected to vacuum, to remove the low boiling solvent and co solvent and leave the substrate impregnated with the treatment agent. The low boiling solvent and co solvent may be condensed and returned to reservoir 100 for further use.

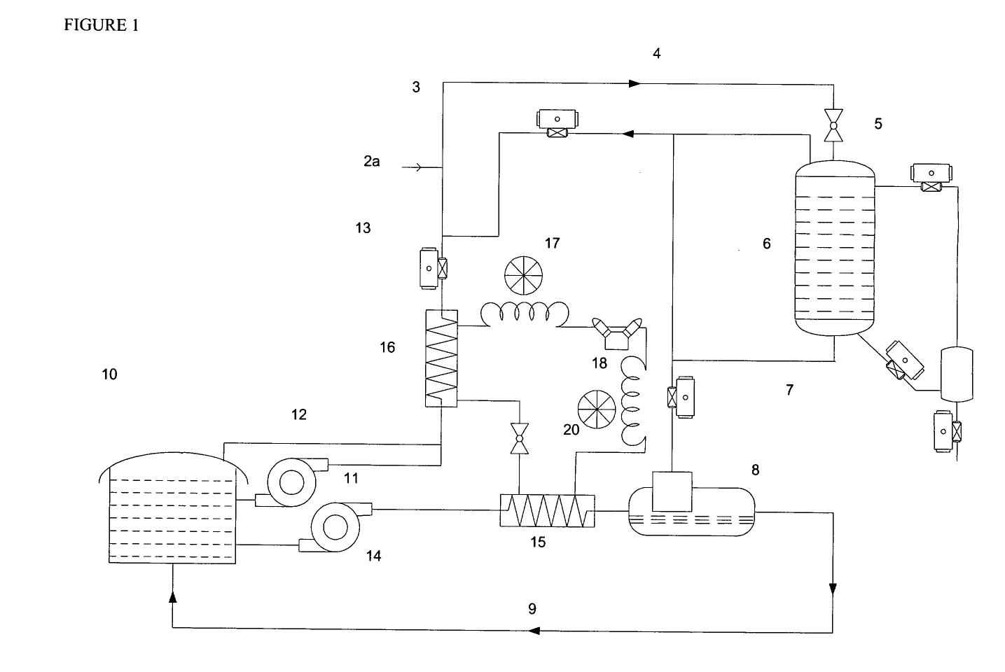

The invention will now be more particularly described with reference to FIG. 1. FIG. 1 shows an apparatus in accordance with the present invention. A source of low boiling solvent at a predetermined temperature and pressure initially supplies the liquid solvent to junction 2a where it is allowed to contact an active agent is introduced from a pressure vessel or input port 2. Co-solvent is added to the active prior to introduction from input port 2 if required. The active solution thus produced (the impregnation fluid) is then passed to a treatment vessel 6 at a predetermined temperature and pressure. The treatment vessel contains a porous substrate, such as portions of wood to be treated. The porous substrate is maintained in contact with the solvent active mixture for a desired period of time, usually a few minutes. The solvent and active agent migrate into the pores. Without wishing to be limited by theory it is believed that there is no preferential uptake of active over solvent or vice versa. What is preferential is the subsequent preferential removal of low boiling solvent over active agent. The liquid material in the treatment chamber is pumped off until only a saturated vapour remains. Overall, there is a drop in pressure in the treatment chamber allowing the agent to remain in the porous material while removing low boiling solvent molecules.

The wood is at a slightly higher temperature than the surroundings as it retains some sensible heat from the compressed gas. The atmosphere in the treatment chamber, which may be a gas or saturated vapour contains the solvent and co solvent plus any volatile portion of unused active agent not taken up into the porous material, is then removed from the treatment vessel 6, via pipe 7 by an entrainer. In the entrainer 8, the gases and liquids and any excess active agent are further condensed. The solvent is then passed via pipe 9 to a liquid solvent/active receiving container 10. The liquid solvent at a predetermined temperature may then be passed at a controlled rate by means of a pump 111 and via pipe 12 and inlet 13 back into the junction 2 for re use. Further active agent and co solvent may be added at junction 2 if required.

In an alternative embodiment, a plurality of treatment vessels maybe used to cycle through a range of batch processes. Porous substrate can be loaded into one vessel, while impregnation is taking place in one or more other vessels.

A refrigeration circuit containing a compressor 18, condensor/de-superheater 17, heat exchangers 16 and 15, pumps 11 and 14, and fan 20 is used to control the temperature and pressure differentials at relevant points in the apparatus i.e. for heating and pressurising the solvent and for cooling and reducing the pressure at the entrainer for solvent recovery.

Energy efficiency is maximised by heat balance in the system which is maintained by the condensor/de-superheater 17. Preferably, fan 17 is configured so as to be able to reject total heating and fan 20 is configured so as to be able to reject total cooling.

Any of the commonly used low boiling solvents can be employed in the methods of the present invention, but preferably low boiling HCFC's and HFC's are used. If hydrocarbons are used, they can be used in the presence of flash point suppressants. By low boiling, it is preferable to use solvents which boil below ambient temperatures, as these require less heating and energy consumption to become vapourised and may not require any additional energy.

A number of prior art impregnation procedures have required the use of antiblooming agents when impregnating porous substrates. These antiblooming agents, such as for example, glycols, are required to prevent a “bloom” of active agent from forming on the surface of the porous substrate as the solvent is removed.

The use of the method of the present invention does not require the addition of antiblooming agents. The present invention enables the low boiling solvent to be removed from the porous substrate without the formation of blooms of an active agent on the surface.

It maybe possible to increase the load of active agent in a low boiling solvent by the use of a co-solvent. It is important that the co-solvent be compatible with the low boiling solvent. It is further important that the co-solvent not remain as a residue in the wood once the low boiling solvent is evaporated. The co-solvent should therefore be either itself be extremely low boiling, or form an azeotrope or zeotrope with the low boiling solvent.

A particularly suitable blend has been serendipitously found by the present applicants to be a combination of pentafluoroethane as low boiling solvent and trans-1,2-dichloroethylene as co solvent. The trans-1,2-dichloroethylene is preferably present in amounts of less than 5%, more preferably less than 3%. Despite the fact that trans 1,2-dichloroethane boils at about 48° C., and pentafluorethane boils at −48.5° C., small amounts of the former form an azeotropic or zeotropic mixture with the latter. Experimentally, solutions of 1%, 2% and 3% of trans-1,2-dichloroethylene in pentafluoroethane were found to evaporate fully at 25° C., leaving no residue of trans-1,2-dichloroethylene.

Monitoring of uptake of actives can be performed by analysis of the reservoir material by HPLC, GC, GC/MS and the like, or by simply determining the weight of active residue in an aliquot of the impregnation fluid. Being a closed system, any component of the mixture depleted from the active mixture must be incorporated into the substrate for impregnation. In this way, the uptake of additives can be carefully monitored, as well as the depletion of any solvent additives (for example, flash point suppressants).

If desired, the impregnation processes can be repeated many times. In this way, the amount of active can be accumulated into the porous substrate to an extent not normally achievable by simply soaking. Any given solvent will be able to dissolve a maximum load of active. When the solvent is evaporated, the wood will have deposited active present in the pores. This will not prevent a further charge of fully laden solvent from carrying further active into the wood because none of the previously deposited active will, in fact, be able to re-dissolve into the saturated solvent. When the solvent is removed, further active is accumulated into the wood. The process can be repeated, topping the active up in the solvent if desired.

Alternatively, it maybe possible just to treat the porous substrate with a single application of active.

### EXAMPLES

### Example 1

An apparatus according to FIG. 1 was used. 3.44 kg of liquid R 22 at a temperature of 40° C. and 1400 KPa was mixed with 100 g of copper naphthenate (introduced as an 8% solution in a light hydrocarbon mixture). This solution was pumped into treatment vessel, an autoclave, containing 0.926 kg of radiata pine. The solvents and active and radiata pine are maintained in contact at 1400 KPa for 15 mins. Liquid solvent was then drained off leaving a saturated vapour in the treatment chamber. The pressure was dropped to 100 KPa where upon the temperature of the solvents mixture reduced to −25° C. The remaining R22 solvent was then drawn from the treatment vessel into an entrainer maintained at a temperature of −25° C. Solvent exiting the entrainer was then passed to reservoir 10 for further use.

The dry radiata pine was weighed and it was determined that the increase in weight was 45 g. The amount of Copper impregnated into the timber, at 8% solution, is calculated to equal 0.38% of the timber mass.

### Example 2

The procedures of example 1 were repeated but here the copper naphthenate solution was replaced by a solution being a mixture of 0.9% tri-butyltin naphthenate (TBTN) and 0.04% permethrin in liquid R22. Analysis of the impregnated timber indicate in excess of 0.08% TBTN and 0.02% permethrin in the cross-section.

In both examples, the end grain was sealed to minimise effects of solvent/active ingress via the end grain, to more properly model what would happen in larger pieces of wood.

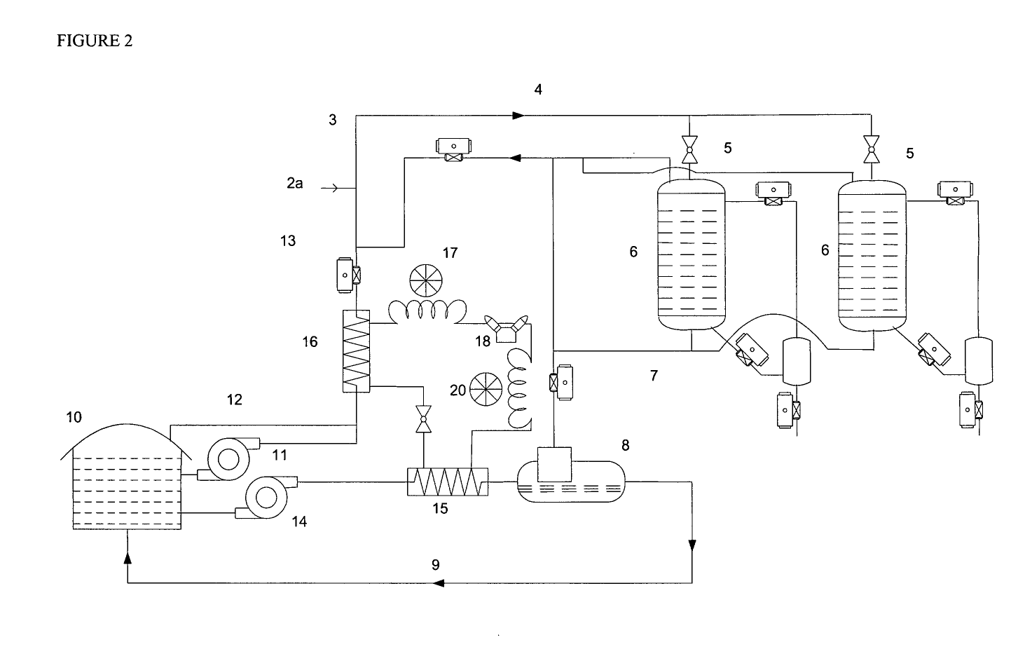

A further extension of the apparatus includes using an additional treatment chamber attached in parallel as shown in FIG. 2. While the material in the first chamber is being impregnated, the second chamber can be isolated from the system, evacuated and vented to the atmosphere and then loaded with wood. When the impregnation in the first chamber is complete, the solvents are removed and the wood dried. While the final drying stage was taking place in the first chamber the solvent and active can cycle round the system and be directed towards the second chamber, where impregnation is commenced. During impregnation, the first chamber is drying with the aid of the entrainer and is isolated from the system and unloaded.

In this way, the system could be used to run a number of alternate batch processes so that the system was always impregnating timber. The use of excess solvent in the system means that one chamber can be drying by entrainment, while another chamber can be impregnating.

In larger systems, where problems with depletion of active in some parts of the loop may be expected, the apparatus can be operated such that all the solvent active can be returned to the reservoir periodically for standardisation of concentration throughout the system.

A monitoring system for feedback of the active agent can be employed to compare the amount of active against the amount of solvent. When the amount of active drops, the system is prompted to introduce a predetermined amount of active agent into the flow.

1. An apparatus for impregnating a porous substrate with an active agent, said apparatus including:
(a) a reservoir for containing a low boiling fluid,
(b) a controllable first fluid pathway to permit fluid to flow from said reservoir to a treatment vessel
(c) a fluid junction for introducing an active agent into said first fluid pathway to permit mixing of said active agent with said low boiling fluid to produce an impregnation fluid containing an initial level of active agent;
(d) a controllable second fluid pathway to allow fluid to flow from said treatment vessel to said reservoir; and wherein
said treatment vessel is adapted to contain said porous substrate and permit said porous substrate to contact said impregnation fluid in a liquid state to produce a treated substrate impregnated with an increased amount of said active agent relative to the porous substrate and a depleted impregnation fluid with a reduced amount of active agent relative to the impregnation fluid.

2. Apparatus according to claim 1 further comprising a co-solvent fluid junction for combining a co-solvent with said active and/or combining a co-solvent with said low boiling fluid.

3. Apparatus according to any one of the preceding claims including a pump for introducing said impregnation fluid via said first fluid pathway into said treatment vessel at a controlled rate.

4. Apparatus according to any one of the preceding claims including temperature control means for introducing said active mixture to said treatment vessel at a predetermined temperature.

5. Apparatus according to any one of the preceding claims further including a pump for removing said residual impregnation fluid via said second fluid pathway.

6. Apparatus according to any one of the preceding claims further including a pump for removing at least a portion of said residual impregnation fluid in a liquid state via said second fluid pathway to a said reservoir and an entrainer for removing at least a portion of said residual impregnation fluid in a gaseous state via said second fluid pathway to said reservoir.

7. Apparatus according to any one of the preceding claims wherein the treatment vessel is configured such that the porous substrate is contacted by a liquid impregnation fluid with minimal or no contact of the porous material by low boiling solvent vapours.

8. Apparatus according to claim 7 wherein the first fluid pathway joins a lower portion of the treatment vessel.

9. Apparatus according to any one of the preceding claims wherein the treatment vessel is sized with respect to the porous material to be substantially filled thereby.

10. Apparatus according to any one of the preceding claims including temperature control means in the treatment vessel.

11. Apparatus according to any one of the preceding claims wherein the temperature control means is a heater and/or cooler

12. Apparatus according to any one of the preceding claims wherein the treatment chamber can be pressurised up to 2000 KPa.

13. Apparatus according to any one of the preceding claims wherein pressure is controlled by a regulator which controls a volume of the impregnation fluid in the treatment vessel.

14. Apparatus according to claim 7 wherein the entrainer is maintained at a temperature at or below that of the treatment vessel.

15. Apparatus according to claim 7 including at least one heat exchanger operating with the entrainer to provide a heat balance and to control pressure differentials throughout the system.

16. Apparatus according to claim 15 including a heat exchanger to heat the impregnation fluid in the first fluid pathway and increase the pressure thereof prior to entering the treatment vessel.

17. Apparatus according to claim 15 or 16 including a heat exchanger to cool the depleted impregnation fluid and provide a low pressure at the entrainer to further cool and condense the mixture.

18. Apparatus according to any one of the preceding claims including a refrigeration circuit.

19. Apparatus according to any preceding claim wherein the system is configured such that energy efficiency is maximised by maintaining heat balance in the system by way of a condensor/de-superheater.

20. Apparatus according to any one of the preceding claims which is a closed system which allows for recovery and recycling of the solvent.

21. Apparatus according to any one of the preceding claims which is fluid tight at elevated pressures.

22. Apparatus according to any preceding claim wherein the fluid junction is an injector port for the introduction of a predetermined amount of said active agent, either alone or in combination with a low boiling solvent or another active or inert carrier.

24. Apparatus according to any one of the preceding claims wherein the treatment vessel includes a vacuum pump to remove residual low boiling solvent from the treatment vessel and/or from the porous substrate.

25. Apparatus according to any one of the preceding claims wherein the treatment vessel further includes a microwave source to apply microwave energy to said porous material to assist in removal of the low boiling solvent and/or impregnation fluid and/or depleted impregnation fluid after the impregnation of said porous material.

26. Apparatus according to any one of the preceding claims having multiple reservoirs or inlet ports to facilitate multiple impregnation steps.

27. A method for impregnating a substrate with an active agent, said method including:
a) preparing an impregnation fluid including a low boiling solvent and an active agent;
b) contacting a porous substrate with said impregnation fluid in a liquid state in an impregnation chamber for a time sufficient to allow said fluid to penetrate the pores of said porous substrate; and
c) removing said impregnation fluid in a liquid state from said impregnation chamber and returning to a reservoir.

28. A method according to claim 27 including a subsequent step of entraining fluids in a gaseous state from said impregnation chamber, condensing said fluids to a liquid state and returning to said reservoir.

29. A method according to any one of claims 27 to 28 wherein the porous substrate has no, or minimal, contact with solvent in the vapour phase.

30. A method according to any one of claims 27 to 29 wherein the impregnation fluid is removed from the treatment chamber and the treatment chamber is subject to vacuum to remove any residual low boiling fluid in the chamber.

31. A method according to any one of claims 27 to 30 wherein the impregnation fluid is removed from the treatment chamber and the treatment chamber is subject to vacuum to remove any residual low boiling fluid in the porous substrate.

32. A method according to any one of claims 27 to 31 further including the application of microwave energy for the removal of solvents from said porous substrate.

33. A method according to any one of claims 27 to 32 wherein the impregnation fluid is prepared by introduction of said active agent into said solvent.

34. A method according to any one of claims 27 to 33 wherein the solvent is a low boiling hydrocarbon, low boiling hydrochlorofluorocarbon or hydrofluorocarbon.

35. A method according to any one of claims 27 to 34 wherein the solvent is selected from, methane, ethane, propane, butane, isobutane, fluorinated hydrocarbons such as chlorodifluoromethane (R22), 1,1,1,2-tetrafluoroethane (R134a), 1,1,1-trifluoroethane (R143a), pentafluoroethane (R125), 1,1,1-difluoroethane (R152a) and difluoromethane (R32).

36. A method according to claim 35 wherein the solvent is pentafluoroethane (R125).

37. A method according to any one of claims 27 to 36 wherein the impregnating fluid further includes a co-solvent to solubilizing the active in the low boiling solvent.

38. A method according to claim 37 wherein the co-solvent is present in an amount of less than 5%.

39. A method according to claim 38 wherein the co solvent is present in an amount of 1%.

40. A method according to claim 38 wherein the co solvent is present in an amount of 2%.

41. A method according to claim 38 wherein the co solvent is present in an amount of 3%.

42. A method according to any one of claims 37 to 41 wherein the co solvent has a boiling point lower than the boiling point of the low boiling solvent.

43. A method according to any one of claims 37 to 42 wherein the co solvent forms an azeotrope or zeotrope with the low boiling solvent.

44. A method according to claim 43 wherein the co solvent forms an azeotrope or zeotrope with the low boiling solvent at the temperatures and pressures at which the low boiling solvent is volatilised.

45. A method according to any one of claims 37 to 44 wherein the co solvent is 1,2-dichloroethylene.

46. A method according to any one of claims 37 to 45 wherein the co solvent is trans-1,2-dichloroethylene.

47. A method according to any one of claims 37 to 46 wherein the low boiling solvent is pentafluoroethane (R125) or a HFC and the co solvent is trans-1,2-dichloroethylene.

48. A method according to any one of claims 27 to 47 wherein the active is a metallic biocide.

49. A method according to claim 48 wherein the metallic biocide is a copper or tin naphthenate.

50. A method according to any one of claims 27 to 47 wherein the active is a non-metallic biocide.

51. A method according to claim 50 wherein the non-metallic biocide is an azoles or pyrethroid.

52. A method for impregnating a porous substrate with an active agent, said method including subjecting the substrate to an impregnating exposure of a liquid impregnation fluid comprising an active agent and a low boiling solvent; and
volatilising at least a portion of said low boiling solvent to leave a portion of said active in said substrate.

53. A method for impregnating a porous substrate with an active agent, said method including subjecting the substrate to an impregnating exposure of a liquid impregnation fluid comprising an active agent; a low boiling solvent and a co solvent; and volatilising at least a portion of said low boiling solvent and said co solvent to leave a portion of said active in said substrate.

54. A method for impregnating a porous substrate with an active agent, said method including subjecting the substrate to an impregnating exposure of a liquid impregnation fluid comprising an active agent and a low boiling solvent;
removing in liquid form at least some of said liquid impregnation fluid; and
subjecting said substrate to volatilisation to volatilise at least a portion of said low boiling solvent to leave a portion of said active in said substrate.

55. A method for impregnating a porous substrate with an active agent, said method including subjecting the substrate to an impregnating exposure of a liquid impregnation fluid comprising an active agent; a low boiling solvent and a co solvent;
removing in liquid form at least some of said liquid impregnation fluid; and
subjecting said substrate to volatilisation to volatilise at least a portion of said low boiling solvent and said co-solvent to leave a portion of said active in said substrate.

56. A method according to any one of claims 27 to 55 carried in conjunction with a heat exchange system which operates to warm the impregnation fluid and increase the pressure thereof prior to entering the treatment vessel and cool the depleted impregnation fluid and or fluid vapours exiting the treatment chamber.

57. A method according to any one of claims 27 to 56 wherein impregnation is repeated until a predetermined levels of impregnation of the porous material is achieved.

58. A porous substrate impregnated by a method of any one of claims 27 to 57.
